(19) United States
(12) Patent Application Publication
(10) Pub. No.: US 2015/0156243 A1
(43) Pub. Date: Jun. 4, 2015

(54) CONTROLLING RESOURCE USAGE OF ADAPTIVE STREAMING SESSIONS FOR TRANSMISSION VIA A RADIO ACCESS NETWORK

(71) Applicant: Telefonaktiebolaget L M Ericsson (PUBL), Stockholm (SE)

(72) Inventors: Robert Skog, Hasselby (SE); Ann-Christine Eriksson, Grillby (SE); Thorsten Lohmar, Aachen (DE); Mathias Sintorn, Sollentuna (SE)

(73) Assignee: Telefonaktiebolagel LM Ericsson (PUBL), Stockholm (SE)

(21) Appl. No.: 13/812,433

(22) PCT Filed: Nov. 6, 2012
(86) PCT No.: PCT/SE2012/051205

§ 371 Date: Jan. 25, 2013

(51) Int. Cl. H04L 29/06; H04W 72/04; H04W 4/18

(52) U.S. Cl. CPC H04L 65/80; H04W 4/18; H04W 72/044; H04L 65/608

(57) ABSTRACT

A method (400) of controlling resource usage of adaptive streaming sessions for transmission via a Radio Access Network (RAN) is provided. The method comprises identifying (401) at least one adaptive streaming session, determining (402) available bitrates for the identified adaptive streaming sessions, determining (403) a resource allocation of the RAN, determining (404) a target bitrate for each of the identified adaptive streaming sessions, and throttling (405) each of the identified adaptive streaming sessions having a current bitrate which is larger than their respective target bitrate. The respective target bitrates are determined (404) based on the available bitrates and the current resource allocation of the RAN. In this way, an improved distribution of shared air interface resources of the RAN may be achieved. Further, a network node for controlling resource usage of adaptive streaming sessions for transmission via a RAN is provided.

### TECHNICAL FIELD

The invention relates to a method of controlling resource usage of adaptive streaming sessions for transmission via a Radio Access Network (RAN), and a corresponding network node.

### BACKGROUND

There is an increased interest in Hypertext Transfer Protocol (HTTP) streaming techniques, in particular for distribution of video to clients via mobile networks, i.e., Radio Access Networks (RANs), allowing for bitrate adaptation and streaming of live content. This is achieved by providing media content to clients in the form of media segments, i.e., files, each media segment containing media content of certain duration, e.g., five or ten seconds.

Client devices are provided with a manifest file which lists available representations of media content and where to fetch them by means of Uniform Resource Indicators (URIs). By providing different representations of the same content, e.g., having different qualities and corresponding bitrates, clients may dynamically adapt the bitrate by selecting an appropriate representation on a segment-by-segment basis. Typically, the manifest file is fetched at least once at the beginning of the streaming session and may be updated during an ongoing session.

The media segments are provided by a media server and continuously fetched by clients, using HTTP, where they can be merged into a continuous media stream. If the available link bitrate, i.e., the bitrate which is supported by the radio link through which the client communicates with the RAN, changes, the client may select a different representation having a lower, or larger, media bitrate. In this way, use experience may be maximized while network conditions are taken into consideration. Adaptive HTTP Streaming (AHS) techniques typically require the client to measure the available link bitrate and to select an appropriate representation from the manifest file, i.e., a representation which can be delivered safely using the available link bitrate, for download.

The 3rd Generation Partnership Project (3GPP) has standardized AHS, which has been extended by the Motion Picture Experts Group (MPEG) to Dynamic Adaptive Streaming over HTTP (DASH). DASH is also being used as basis for HTTP streaming in Release 10 of 3GPP, called 3GP/MPEG DASH. Other solutions for HTTP streaming are, e.g., HTTP Live Streaming (HLS) by Apple, Smooth Streaming (ISM) by Microsoft, and Adobe Dynamic Streaming.

Different file formats are used for the media segments, such as MPEG2-TS or ISO BMFF, e.g., MP4. Known formats for manifest files are, e.g., Media Presentation Description (mpd) for DASH, m3u8 for HLS, and ismc for ISM.

From a network perspective, in particular RANs, it is undesirable that the bitrate of media streams, and the required resource allocation, is dictated by decisions of clients receiving media streams via the RAN. In particular, this is the case since the bitrate control mechanism, i.e., the rules according to which clients select a representation, is not standardized, and every vendor may implement its own control mechanism. This may lead to an imbalance in resource usage by different clients sharing the radio resources of the RAN.

### SUMMARY

It is an object of the present invention to provide an improved alternative to the above techniques and prior art.

More specifically, it is an object of the present invention to provide an improved control of resource usage of adaptive streaming sessions for transmission via a RAN.

These and other objects of the invention are achieved by means of different aspects of the invention, as defined by the independent claims. Embodiments of the invention are characterized by the dependent claims.

For the purpose of describing the invention, it is to be understood that an adaptive streaming session carries a media stream which delivers media content, such as audio or video, from a source, by which the media content is provided, to a client, where the media content is rendered. For instance, in the case of video, media content may be provided by a media server and delivered to a client, where it is rendered on a display which the client is provided with. The client may, e.g., be a User Equipment (UE), a mobile phone, a smart phone, a tablet computer, a media player, or any other computing device capable of wireless communications via a RAN. In the present context, the term ‘adaptive’ means that a particular media content is available in different representations, each representation being associated with a quality and a corresponding (media) bitrate. Typically, the client selects a representation based on a measured downlink bitrate, such that the corresponding bitrate can be safely downloaded.

The wireless communications may be effected by any suitable radio access technology and/or standard, such as Global System for Mobile Communications (GSM), Universal Mobile Telecommunications System (UMTS), Long Term Evolution (LTE), Wireless Local Area Network (WLAN)/WiFi, Bluetooth, or the like.

According to a first aspect of the invention, a method of controlling resource usage of at least one adaptive streaming session for transmission via a RAN is provided. The method comprises identifying the at least one adaptive streaming session, determining available bitrates for each of the at least one adaptive streaming session, determining a resource allocation of the RAN, determining a target bitrate for each of the at least one adaptive streaming session, and throttling each of the at least one adaptive streaming session having a current bitrate which is larger than their respective target bitrate. The target bitrate for each of the at least one adaptive streaming session is determined based on the available bitrates and the current resource allocation of the RAN.

According to a second aspect of the invention, a network node for controlling resource usage of at least one adaptive streaming session for transmission via a RAN is provided. The network node is arranged for identifying the at least one adaptive streaming session, determining available bitrates for each of the at least one adaptive streaming session, determining a resource allocation of the RAN, determining a target bitrate for each of the at least one adaptive streaming session, and throttling each of the at least one adaptive streaming session having a current bitrate which is larger than their respective target bitrate. The network node is arranged for determining a target bitrate for each of the at least one adaptive streaming session based on the available bitrates and the current resource allocation of the RAN.

The present invention makes use of an understanding that an improved distribution of shared air interface resources of a RAN may be achieved by identifying at least one, but preferably several, adaptive streaming sessions which are delivered to clients accessing the RAN, determining the available bitrates for each adaptive streaming session, monitoring a resource allocation of the RAN, determining a target bitrate for each adaptive streaming session, and throttling adaptive streaming sessions with a current bitrate which exceeds the respective target bitrate. In the present context, shared air interfaces resources are available frequency bands and time slots which may be assigned to clients, e.g., by a scheduler which an access node of the RAN is provided with.

To this end, the respective target bitrate for each adaptive streaming session is determined such that a desired sharing of air interface resources is achieved. In particular, the target bitrates may be determined such that a fair sharing of air interface resources among streaming clients of the RAN is achieved. In this respect, streaming clients are clients which retrieve media content, such as a video, by means of adaptive streaming.

Adaptive streaming sessions may be identified in different ways. For instance, a manifest file (like an ‘mpd’ or an ‘m3u8’ file) transmitted to a client is an indicator for an adaptive streaming session. Further, the URIs used by clients for requesting media segments may be known to the network, i.e., the network knows that certain URIs are associated with streaming services. Even further, the media segments itself which are transmitted to a client may be identified by the response type and the type of the payload.

The target bitrates are determined based on the available bitrates for each adaptive streaming session, and the resource allocation of the RAN. In this way, a desired distribution of the available resources of the RAN, in particular air interface resources, may be accomplished. Preferably, the determination of target bitrates is performed on a per cell basis and takes into account the resource allocation of that particular cell. Optionally, policy or subscription information, as well as information pertaining to services which are available in the cell, may be taken into account. In addition to that, the Quality of User Experience (QoE) of other clients may be taken into account. For example, the target bitrates may also be determined such that clients receiving the throttled streaming sessions are forced to switch to a representation having a lower bitrate.

The target bitrates may be determined individually for each client, e.g., based on radio conditions, subscription or policy information, or type of media content which is streamed. Alternatively, a common target bitrate may be assigned to all, or at least a group of clients, for the purpose of accomplishing a fair sharing of resources.

According to an embodiment of the invention, the at least one adaptive streaming session is an AHS session. However, the invention is not limited to AHS, and embodiments of the invention based on other types of adaptive streaming, relying on bitrate measurements and selection of representations performed by clients, may easily be envisaged.

According to an embodiment of the invention, the available bitrates are determined by inspecting a manifest file. The manifest file may, e.g., be acquired from a media server from which the media content is streamed. Inspecting the manifest file is an easy way of determining bitrates, in particular if the manifest file is not encrypted.

According to an embodiment of the invention, the available bitrates may be determined by retrieving information pertaining to the available bitrates from a network node providing media content for streaming. In particular, the network node may be a media server. The information may be received out-of band. Alternatively, such information may be acquired from another network node. This is advantageous in that the available bitrates may be determined in a direct way, without requiring any further analysis or processing.

According to an embodiment of the invention, the available bitrates are determined by inspecting a media segment. This may, e.g., be performed by identifying the ‘sidx’ box of an ISO BMFF media segment and reading the information provided therein. This is advantageous in that the available bitrates may be derived from the media segments without retrieving information pertaining to available bitrates from the provider of the media content.

According to an embodiment of the invention, the available bitrates are determined by Deep Packet Inspection (DPI). This is advantageous if details about the file format used by the media segments are known.

According to an embodiment of the invention, the throttling is performed by a node of the RAN, such as a NodeB, a Radio Network Controller (RNC), or an eNodeB. In particular, the throttling may be performed by the scheduler of the NodeB or eNodeB. This may, e.g., be achieved by adjusting the weight of a streaming session which is to be throttled, thereby reducing the bitrate. This is advantageous in that no additional throttling unit is required. Rather, the throttling is simply effected by modifying the scheduling algorithm of an existing scheduler.

According to an embodiment of the invention, the throttling is performed by a proxy, such as a Transmission Control Protocol (TCP) proxy or an HTTP proxy. Alternatively, throttling may be performed by a video optimization proxy, or a proxy for traffic shaping. Using a proxy is advantageous in that throttling may be performed at different locations within the RAN, or a core network to which the RAN is connected. Further, such a proxy may be arranged for performing throttling for several access nodes and cells served by these access nodes.

According to an embodiment of the invention, the network node comprises video parsing means. The video parsing means are arranged for identifying the at least one adaptive streaming session, and determining available bitrates for each of the at least one adaptive streaming session. As an alternative, information pertaining to adaptive streaming sessions may be received from an external video parser.

According to an embodiment of the invention, the network node comprises radio resource management (RRM) means. The RRM means are arranged for determining a resource allocation of the RAN. As an alternative, information pertaining to resource allocation may be received from an external RRM unit.

According to an embodiment of the invention, the network node comprises scheduling means. The scheduling means may, e.g., be a scheduler provided in a NodeB or in an eNodeB, which scheduler is used for assigning air interfaces resources to clients accessing the RAN. The scheduling means is arranged for throttling each of the at least one adaptive streaming session having a current bitrate which is larger than their respective target bitrate. As an alternative, throttling may be performed by an external scheduler or throttling unit, by a node for traffic shaping, or by a proxy.

According to an embodiment of the invention, the network node comprises control means. The control means are arranged for determining the target bitrates for each of the at least one adaptive streaming session. As an alternative, the target bitrates may be determined by an external control unit.

Even though advantages of the invention have in some cases been described with reference to embodiments of the method according to the first aspect of the invention, corresponding reasoning applies to embodiments of the network node according to the second aspect of the invention.

Further objectives of, features of, and advantages with, the invention will become apparent when studying the following detailed disclosure, the drawings and the appended claims. Those skilled in the art realize that different features of the invention can be combined to create embodiments other than those described in the following.

### BRIEF DESCRIPTION OF THE DRAWINGS

The above, as well as additional objects, features and advantages of the invention, will be better understood through the following illustrative and non-limiting detailed description of embodiments of the invention, with reference to the appended drawings, in which:

FIG. 1 illustrates a system for streaming media to a client via a RAN.

FIG. 2 illustrates fetching of media segments by a client.

FIG. 3 schematically illustrates a system for controlling resource usage of adaptive streaming sessions for transmission via a RAN, in accordance with an embodiment of the invention.

FIG. 4: illustrates a method of controlling resource usage of adaptive streaming sessions for transmission via a RAN, in accordance with an embodiment of the invention.

FIG. 5: illustrates a network node for controlling resource usage of adaptive streaming sessions for transmission via a RAN, in accordance with an embodiment of the invention.

FIG. 6: illustrates a network node for controlling resource usage of adaptive streaming sessions for transmission via a RAN, in accordance with another embodiment of the invention.

FIG. 7: illustrates a network node for controlling resource usage of adaptive streaming sessions for transmission via a RAN, in accordance with a further embodiment of the invention.

FIG. 8: illustrates a network node for controlling resource usage of adaptive streaming sessions for transmission via a RAN, in accordance with yet another embodiment of the invention.

All the figures are schematic, not necessarily to scale, and generally only show parts which are necessary in order to elucidate the invention, wherein other parts may be omitted or merely suggested.

### DETAILED DESCRIPTION

The invention will now be described more fully herein after with reference to the accompanying drawings, in which certain embodiments of the invention are shown. This invention may, however, be embodied in many different forms and should not be construed as limited to the embodiments set forth herein. Rather, these embodiments are provided by way of example so that this disclosure will be thorough and complete, and will fully convey the scope of the invention to those skilled in the art.

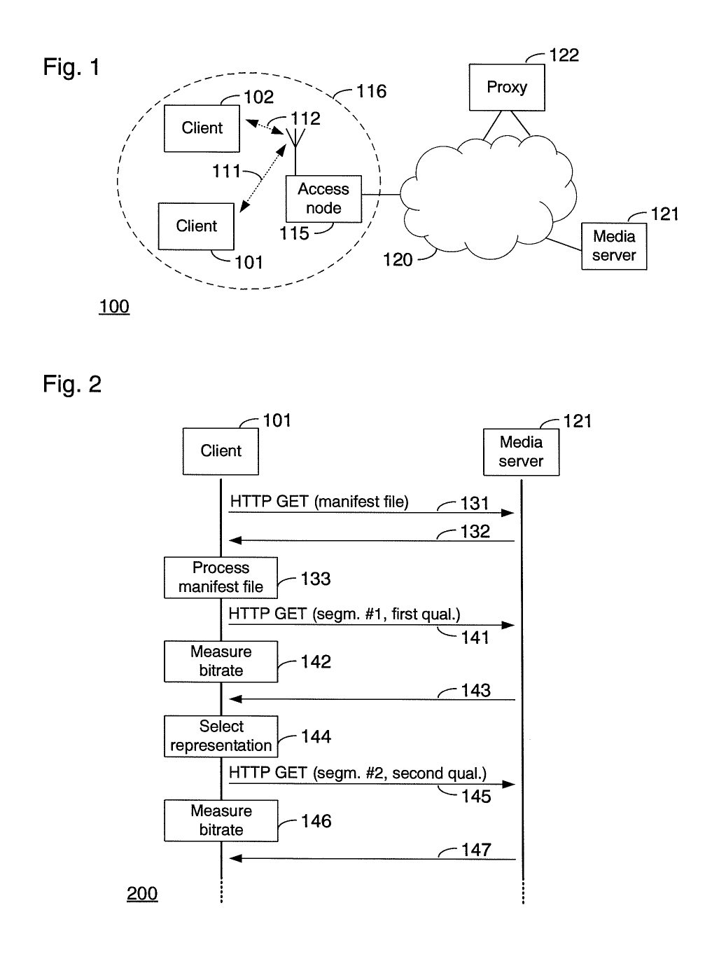

In FIG. 1, a system for delivering media by way of streaming to mobile clients via a RAN is illustrated.

System 100 comprises two clients 101 and 102 which access a RAN 116 through an access node 115, such as a Radio Base Station (RBS), a NodeB, an eNodeB, a WLAN access point, or the like, capable of effecting wireless communications with clients 101 and 102, via radio links 111 and 112, respectively. Clients 101 and 102 may be mobile terminals, UEs, smartphones, computers, media players, or any other type of computing device capable of effecting wireless communications with access node 115, and for being engaged in a streaming session, i.e., receiving a media stream. It will be appreciated that, even though two clients 101 and 102 are illustrated in FIG. 1, embodiments of the invention are not limited to RANs being accessed by two clients.

Access node 115 is connected, via a communications network 120, to a media server 121 and, optionally, a proxy 122. A client, e.g., client 101, may access media content provided by media server 121 by requesting a media stream from media server 121. The media stream is delivered, i.e., transmitted, via a streaming session from media server to access node 115, either directly via communications network 120, or via proxy 122, to access node 115 and further to client 101.

Access node 115 allocates radio resources for transmitting the media stream to client 101 by means of radio link 111 which is established between client 101 and access node 115. Typically, radio links in a RAN, such as radio links 111 and 112 shown in FIG. 1, are suitable for effecting wireless communications both in uplink, i.e., from a client to a RAN access node, and in downlink, i.e., from the access node to the client. Depending on the radio technology employed by the RAN, and the standard according to which the wireless communications are effected, different types of radio channels may be set up between client and access node, each type of radio channel having a supported link bitrate as well as a resource consumption associated with it. As a general rule, the resource consumption associated with a radio channel, e.g., power consumption in the access node and the client, increases with increasing supported bitrate. Consequently, a high-bitrate channel, e.g., a High-Speed Downlink Packet Access (HSDPA) channel, consumes more power than a low-bitrate channel, e.g., a Forward Access Channel (FACH). This is of particular importance in battery powered clients where battery lifetime is an issue.

In the following, the principle of streaming media to mobile clients, i.e., clients accessing media content via a RAN, using an adaptive streaming session, in particular based on AHS, is described with reference to FIG. 2.

For the purpose of describing embodiments of the invention, it is assumed that a media stream is delivered to clients by means of media segments comprising media content of certain duration, e.g., five or ten seconds. The media content may be coded in a suitable file format. The same media content, e.g., an audio sequence or a video, may be provided in different representations which are characterized by different media qualities and associated bitrates. In other words, a client may request a video in a low resolution, if only a low link bitrate is available to the client, or in a high resolution, if a higher link bitrate is available to the client. The different representations which are available to a client are described in a manifest file which provides the client with information where to fetch corresponding media segments. This information may, e.g., be provided by means of URIs.

The available link bitrate is typically dependent on network conditions, such as network load, and radio conditions. In adaptive streaming techniques, such as AHS, the client is responsible for measuring the available link bitrate and selecting a suitable representation, i.e., a representation having an associated bitrate which can be safely delivered to the client in view of the available link bitrate. Typically, a client measures the time interval during which a complete media segment is received. From the measured time interval, and the amount of data carried by a media segment, the available link bit rate may be calculated.

Further with reference to FIG. 2, a session 200 for streaming media from media server 121 to client 101 using AHS is described. Session 200 is initiated by client 101 requesting 131 a manifest file from media server 121. This is accomplished by sending an HTTP GET message 131 requesting the manifest file. In response to the request 131, media server 121 transmits 132 the manifest file to client 101. Then, client 101 processes 133 the manifest file and selects a suitable representation of the media content, e.g., a video, to which the manifest file relates. For instance, client 101 may select a first, low, quality based on an estimation of an available link bitrate. Subsequently, client 101 requests 141, using HTTP GET, the first media segment of the selected representation. The information which is transmitted with HTTP GET request 141 indicates that the first media segment, being coded in a first quality, is requested. This information may, e.g., be conveyed by means of URIs, as described in the manifest file. In response to receiving HTTP GET request 141, media server 121 transmits 143 the first media segment coded in a first quality to client 101.

During the process of receiving the first media segment, transmitted 143 by media server 121 to client 101, client 101 measures the available link bitrate. This may, e.g., be accomplished by measuring the time which lapses between receiving the first data relating to the transmission 143 of the first media segment, and receiving the final data relating to the transmission 143 of the first media segment.

Then, the available link bitrate may be calculated by dividing the amount of data transmitted 143 to client 101 by the lapsed time. This yields an effective bitrate averaged over the time interval between receiving the first data and receiving the final data. This time interval is typically of the same size as the duration of media content comprised in the media segment, i.e., of the order of a few or up to ten seconds.

Client 101 may use the estimated available link bitrate in order to select 144 a different representation, having a second quality being different than the first quality, for requesting the second media segment or subsequent media segments. For instance, if the available link bitrate is sufficient to support a higher quality, client 101 may select 144a suitable representation by using corresponding URIs for requesting subsequent media segments. If, on the other hand, the available link bitrate is too small to safely transmit media segments being coded with the first quality, client 101 may select 144 an even lower quality. In this respect, client 101 may use a certain safety margin when selecting a representation which may be safely transmitted to the client, in order to take changes in the radio conditions into account.

After selecting 144 a representation, client 101 requests 145 the second media segment from media server 121, using HTTP GET. Media server 121 transmits 147, in response to request 145, the second media segment to the client. While receiving the second media segment, client 101 measures the available link bitrate, i.e., the effective, averaged, link bitrate during the time interval between receiving the first data of the second media segment and receiving the final data of the second media segment, as was described hereinbefore.

Session 200 may continue with the client 101 requesting subsequent media segments from media server 121. Each media segment is delivered to client 101 by requesting a certain media segment of a certain representation, i.e., quality, and receiving the request media segment from media server 121. Optionally, client 101 may measure the available link bitrate and select a suitable representation. It will be appreciated that client 101 may be arranged for conducting link bitrate measurements for each requested media segment. As an alternative, client 101 may be arranged for conducting link bitrate measurements periodically, or only if certain conditions are met, e.g., if radio conditions get worse, such as a decreasing received signal strength measured by client 101.

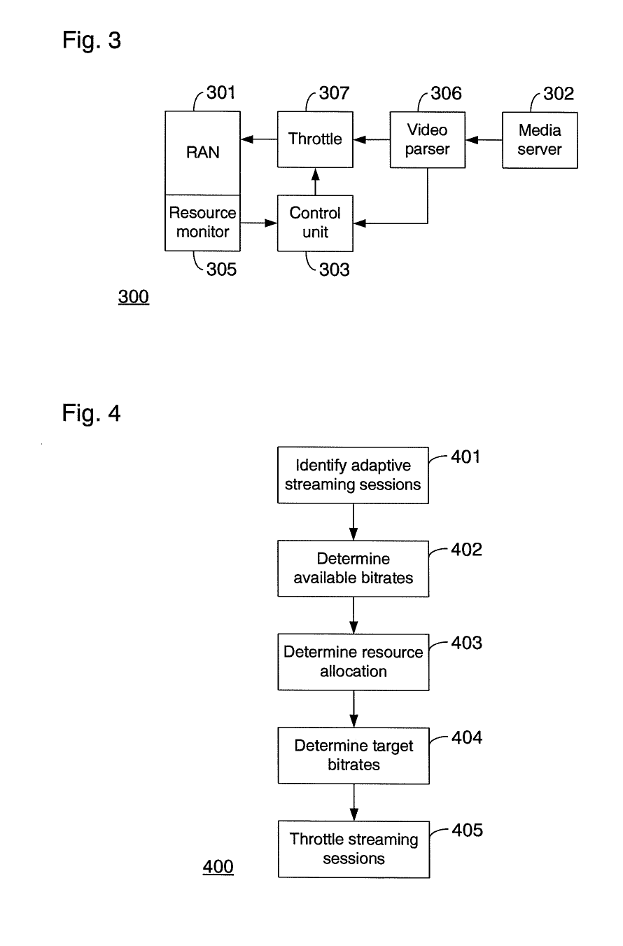

FIG. 3 schematically illustrates a system 300 for controlling resource usage of adaptive streaming sessions for transmission via a RAN, in accordance with an embodiment of the invention.

In FIG. 3, RAN 301 comprises an access node for allowing clients to access a communications network, as was described with reference to FIG. 1. In particular, clients accessing RAN 301 may retrieve media from a media server 302 by way of streaming, as was described with reference to FIG. 2, and specifically by means of AHS. However, embodiments of the invention based on other adaptive streaming techniques may be envisaged.

Arrangement 300 differs from system 100, described with reference to FIG. 1, in that a media stream transmitted from media server 302 to RAN 301 passes a video parser 306 and a throttling unit 307 before it is received at RAN 301. Video parser 306 is arranged for identifying at least one adaptive streaming session, and preferably several adaptive streaming sessions, which are transmitted to RAN 301, and for determining available bitrates for each of these adaptive streaming sessions. The information pertaining to the identified adaptive streaming sessions and their respective available bitrates is communicated to a control unit 303. Control unit 303 is further arranged for acquiring information pertaining to a resource allocation of RAN 301 from a resource monitor 305 associated with RAN 301.

Control unit 303 is further arranged for determining a target bitrate for each of the identified adaptive streaming sessions. The target bitrates are determined based on the available bitrates, as provided by video parser 306, and the resource allocation of the RAN, as provided by resource monitor 305. In this way, a desired distribution of the available resources of RAN 301, in particular air interface resources, may be accomplished. Preferably, the determination of target bitrates by control unit 303 is performed on a per cell basis and takes into account the resource allocation of a particular cell of RAN 301. Optionally, policy or subscription information, as well as information pertaining to services which are available in the cell, may be taken into account. In addition to that, the QoE of other clients may also be considered. Further, the target bitrates may also be determined such that clients receiving the streaming sessions throttled by throttling unit 307, as is described hereinafter, are forced to switch to a representation having a lower bitrate.

The target bitrates are communicated from control unit 303 to throttling unit 307 which is arranged for throttling adaptive streaming sessions which have a current bitrate which is larger than the respective target bitrate for that session. After passing throttling unit 307, the adaptive streaming sessions, and other data which has not been identified as being part of an adaptive streaming session, is transmitted to RAN 301 and, subsequently, to the requesting clients.

Further with respect to FIG. 3, video parser 306 may be arranged for determining the available bitrates by inspecting a manifest file which is transmitted from media server 302 to clients requesting media content to which the manifest relates. As an alternative, video parser 306 may be arranged for acquiring information pertaining to the available bitrates from media server 302, or any other network node providing media content to clients accessing RAN 301. This may be advantageous if the manifest files provided by media server 302 are encrypted. Even further, video parser 306 may also be arranged for determining the available bitrates by inspecting a media segment which is transmitted from media server 302 to RAN 301, and which is part of the media content which is streamed to a client on request. By inspecting one or more media segments, e.g., by means of DPI, video parser 306 may derive the respective bitrate of a media segment. For instance, this may be achieved by determining the amount of data contained in a media segment and the duration of media content of that media segment. In case of an ISO BMFF media segment, the ‘sidx’ box may be identified and information provided therein may be inspected. In this way, by inspecting several media segments having different bitrates, video parser 306 may learn which bitrates are available. Preferably, video parser 306 is arranged for continuously inspecting media segments streamed from media server 302 to RAN 301.

In FIG. 4, an embodiment of the first aspect of the invention is illustrated, relating to a method of controlling resource usage of adaptive streaming sessions, in particular AHS sessions, for transmission via a RAN.

Method 400 starts with identifying 401 at least one adaptive streaming session. Preferably, several adaptive streaming sessions are identified. Then, in step 402, available bitrates are determined for each of the identified adaptive streaming sessions. For instance, the available bitrates may be determined by inspecting a manifest file provided by the media server from which media is streamed. As an alternative, information pertaining to the available bitrates may be acquired from the media server, or another network node providing media content for streaming. Even further, the available bitrates may be determined by inspecting a media segment, as was described hereinbefore.

In step 403, a resource allocation of the RAN is determined. Information pertaining to resource allocation of the RAN is preferably acquired from the RAN, e.g., from an access node of the RAN, such as an RBS, a NodeB, or an eNodeB, but may alternatively be acquired from an RNC. In particular, such information may be obtained from an RRM entity of such a node.

Subsequently, a target bitrate is determined 404 for each of the identified adaptive streaming sessions. The target bitrates are determined based on the available bitrates (determined in step 402), and the current resource allocation of the RAN (determined in step 403).

Finally, each of the identified adaptive streaming sessions having a current bitrate which is larger than their respective target bitrate is throttled 405.

An embodiment of method 400 may be implemented in a node of the RAN, e.g., an RBS, a NodeB, an eNodeB, or an RNC. Alternatively, an embodiment of method 400 may be implemented in a proxy server, such as a TCP or HTTP proxy, in a video optimization proxy, or in a proxy for traffic shaping.

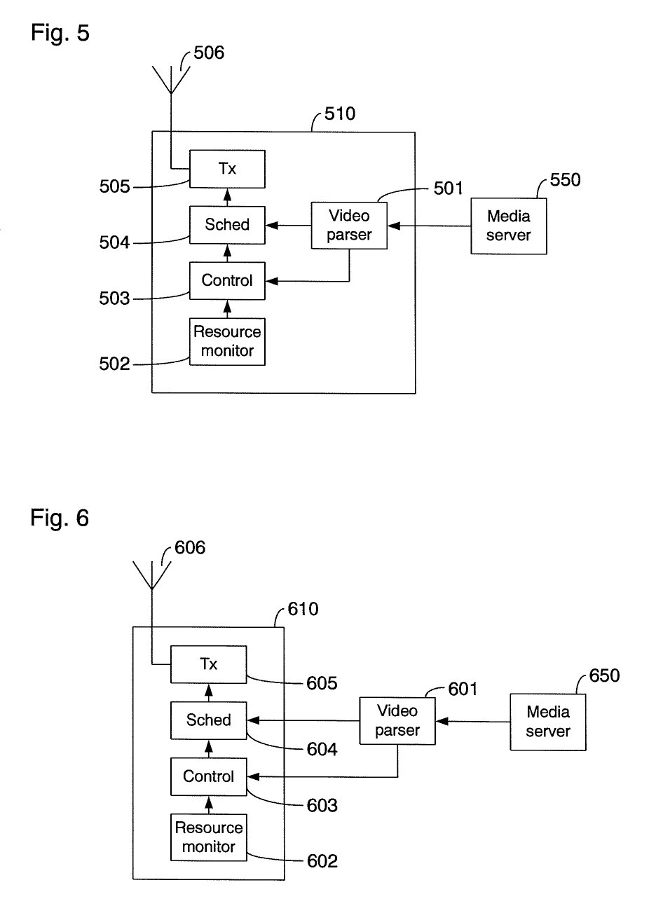

Even though system 300 has been described, with reference to FIG. 3, as comprising distinct functional units 301-307, embodiments of the invention are not limited to such distinct units. Rather, embodiments are the invention may be based on one or more nodes which, alone or in combination, implement functional units 301-307 which, when put into operation, perform in accordance with an embodiment of the invention, as is exemplified hereinafter with reference to FIGS. 5 to 8.

In the following, embodiments of the second aspect of the invention are illustrated, relating to network nodes for controlling resource usage of adaptive streaming sessions delivered to clients via a RAN. In the described embodiments, functional units 301-307 are combined in different ways. Regardless of how, and among how many nodes, functional units 301-307 are distributed, these units are arranged to interact with each other so as to perform in accordance with an embodiment of the invention.

FIG. 5 illustrates a network node for controlling resource usage of adaptive streaming sessions for transmission via a RAN, in accordance with an embodiment of the invention.

Network node 510 comprises a video parser 501, a resource monitor 502, a control unit 503, a scheduler 504, a radio transmitter 505, and an antenna 506. Video parser 501, resource monitor 502, and control unit 503, operate in accordance with their corresponding functional units 306, 305, and 303, respectively, described with reference to FIG. 3. Scheduler 504 is arranged for assigning radio resources, i.e., frequency bands and time slots, to transmissions in both uplink and downlink, as is known in the art. In FIG. 5, scheduler 504 is illustrated to receive data for transmission from a communications network, and in particular from a media server 550, schedule data for transmission, and send scheduled data to radio transceiver 505 which is arranged for transmitting the scheduled data using antenna 506.

Network node 510 may be an access node of a RAN, such as an RBS, a NodeB, or an eNodeB. In this case, resource monitor 502 may be an RRM unit of network node 510, and scheduler 504 may be a scheduler which RAN access nodes typically are provided with, and which is adapted to take target bitrate decisions received from control unit 503 into account. This may, e.g., be accomplished by adjusting a respective weight associated with the identified adaptive streaming sessions such that the desired throttling is achieved. For instance, if the target bitrate for a certain adaptive streaming session, as determined by control unit 503, is smaller than the current bitrate of that streaming session, the associated scheduling weight may be lowered, thereby effectively reducing the bitrate. Alternatively, network node 510 may be an RNC.

In FIG. 6, an alternative arrangement of functional units 301-307 is illustrated. Network node 610 is similar to network node 510 described with reference to FIG. 5, in that it comprises resource monitor 602, control unit 603, scheduler 604, radio transmitter 605, and antenna 606, which correspond to units 502-506 illustrated in FIG. 5. However, contrary to FIG. 5, video parser 601, corresponding to video parser 501, is located outside network node 610. For instance, video parser 601 may be located within a proxy server, an RNC, a video optimization proxy, or any other network node involved in routing or delivering streaming sessions from a media server 650 to network node 610. Network node 610 may be an RBS, a NodeB, an eNodeB, or an RNC.

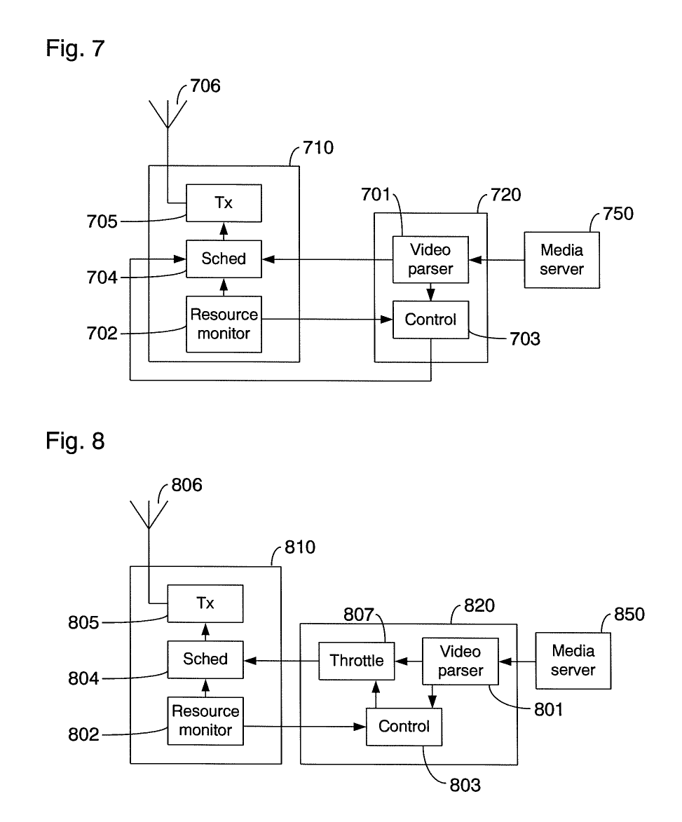

A further alternative arrangement of functional units 301-307 is illustrated in FIG. 7. Here, resource monitor 702, scheduler 704, and antenna 705, are comprised in network node 710, whereas video parser 701 and control unit 703 are comprised in a separate network node 720. Units 701-706 correspond to units 501-506 illustrated in FIG. 5. Network node 710 may be an RBS, a NodeB, an eNodeB, or an RNC. Network node 720 may be a proxy server, an RNC, a video optimization proxy, or any other network node involved in routing or delivering streaming sessions from a media server 750 to network node 710.

Finally, yet a further arrangement of functional units 301-307 is illustrated in FIG. 8. Network node 810, which may be an RBS, a NodeB, an eNodeB, or an RNC, comprises resource monitor 802, scheduler 804, radio transmitter 805, and antenna 806. Video parser 801 and control unit 803 are comprised in a separate network node 820, which may be a proxy server, an RNC, a video optimization proxy, or any other network node involved in routing or delivering streaming sessions from a media server 850 to network node 810. Network node 820 further comprises a throttling unit 807 which is arranged for throttling adaptive media streams by taking target bitrate decisions received from control unit 803 into account. Thus, rather than utilizing the scheduler of an access node, such as schedulers 504, 604, or 704, for throttling adaptive streaming sessions having a current bitrate exceeding their respective target bitrate, a separate throttling unit 807 is provided for this purpose.

The person skilled in the art realizes that the present invention by no means is limited to the embodiments described above. On the contrary, many modifications and variations are possible within the scope of the appended claims. In particular, it will be appreciated that functional units 301-307, described with reference to FIG. 3, may be arranged in different ways, other than what has been illustrated in FIGS. 5 to 8.

1. A method of controlling resource usage of one or more adaptive streaming sessions for transmission via a Radio Access Network, RAN, the method comprising:
identifying the one or more adaptive streaming sessions,
determining available bitrates for the one or more adaptive streaming sessions,
determining a resource allocation of the RAN,
determining, based on the available bitrates and the current resource allocation of the RAN, a target bitrate for the one or more adaptive streaming sessions, and
throttling the one or more adaptive streaming sessions having a current bitrate which is larger than their respective target bitrate.

2. The method according to claim 1, wherein the one or more adaptive streaming sessions are an Adaptive HTTP Streaming, AHS, session.

3. The method according to claim 1, wherein the available bitrates are determined by inspecting a manifest file.

4. The method according to claim 1, wherein information pertaining to the available bitrates is acquired from a network node providing media content for streaming.

5. The method according to claim 1, wherein the available bitrates are determined by inspecting a media segment.

6. The method according to claim 5, wherein the available bitrates are determined by Deep Packet Inspection, DPI.

7. The method according to claim 1, wherein the throttling is performed by a node of the RAN.

8. The method according to claim 1, wherein the throttling is performed by a proxy.

9. A network node for controlling resource usage of one or more adaptive streaming sessions for transmission via a Radio Access Network, RAN, the network node being arranged for:
identifying the at least one or more adaptive streaming sessions,
determining available bitrates for the one or more adaptive streaming sessions,
determining a resource allocation of the RAN,
determining, based on the available bitrates and the current resource allocation of the RAN, a target bitrate for the one or more adaptive streaming sessions, and
throttling the one or more adaptive streaming sessions having a current bitrate which is larger than their respective target bitrate.

10. The network node according to claim 9, comprising control means being arranged for determining the target bitrate for the one or more adaptive streaming sessions.

11. The network node according to claim 9, comprising a video parser being arranged for:
identifying the one or more adaptive streaming sessions, and
determining the available bitrates for the one or more adaptive streaming sessions.

12. The network node according to claim 9, comprising a Radio Resource Management, RRM, unit, being arranged for determining the resource allocation of the RAN.

13. The network node according to any claim 9, comprising a scheduler being arranged for throttling the one or more adaptive streaming sessions having a current bitrate which is larger than their respective target bitrate.

14. The network node according to claim 9, wherein the one or more adaptive streaming sessions is an Adaptive HTTP Streaming, AHS, session.

15. The network node according to claim 9, being arranged for determining the available bitrates by inspecting a manifest file.

16. The network node according to claim 9, being arranged for acquiring information pertaining to the available bitrates from a network node providing media content for streaming.

17. The network node according to claim 9, being arranged for determining the available bitrates by inspecting a media segment.

18. The network node according to claim 17, being arranged for determining the available bitrates by Deep Packet Inspection, DPI.

19. The network node according to claim 9, being an access node of the RAN.

20. The network node according to claim 9, being a proxy.
